(19) United States
(12) Patent Application Publication
(10) Pub. No.: US 2006/0106868 A1
(43) Pub. Date: May 18, 2006

(54) Information processing systems and methods thereor

(76) Inventor: Youngtack Shim, Port Moody (CA)

Correspondence Address: Youngtack Shim, 155 Aspenwood Drive, Port Moody, BC, V3H 5A5, CA

(21) Appl. No.: 10/989,484

(22) Filed: Nov. 17, 2004

(51) Int. Cl. G06F 17/00; G06F 7/00

(52) U.S. Cl. 707/104.1

(57) ABSTRACT

The present invention generally relates to various information processing systems and related methods arranged to acquire raw images and/or raw sounds, to extract therefrom text, visual, and/or audible informations, to process (e.g., edit and/or modify) such informations so as to obtain processed images and/or processed sound, and to output such processed images and/or processed sounds in a preset pattern. More particularly, such information processing systems and methods of this invention may preferably allow users to synchronize different or similar informations acquired independently or at different instants. Accordingly, the users may acquire text, visual, and/or audible informations from different sources at different instants and may edit and/or modify them to provide more synchronized informations for future references. In addition, such information processing systems of this invention may preferably be constructed as portable systems, may be arranged to retrofit conventional devices, and/or may be incorporated into other conventional portable devices such as, e.g., cell phones, PDAs, data organizers, and laptop computers.

The present application claims a benefit of an earlier invention date pertinent to the Disclosure Document which has been deposited in the U.S. Patent and Trademark Office by the same Applicant on Mar. 14, 2003 under its Disclosure Document Deposit Program, which is entitled as “Information Processing Systems and Methods Therefor,” and which also bears a Ser. No. 527,998, an entire portion of which is to be incorporated by reference herein.

### FIELD OF THE INVENTION

The present invention relates to various information processing systems and related methods for acquiring raw images and/or raw sounds, extracting therefrom text information, visual information, and/or audible information, providing processed images and/or processed sounds by processing one of more such informations, and displaying and/or playing such processed images and/or processed sounds. The information processing systems and methods of the present invention may be arranged to allow users to synchronize different or similar informations acquired independently of each other or acquired at different instants. Therefore, the users may be able to acquire text, visual, and/or audible informations from different sources and/or at different instants, to edit and/or to modify one of more of such informations according to their needs, and to synchronize two or more of such informations for future reference.

### BACKGROUND OF THE INVENTION

Circumstances arise during a course of business or during a regular daily life when a person has to exchange informations with another person. Thereafter, the exchanged information somehow has to be rearranged or reorganized for better future references. Any person engaged in a business keeps a stack of business cards which may be inserted into holding sheets or stacked in the Rolodex. Such a person has to keep and to carry with him or her tens of importune phone numbers in a pocket book, cell phone, personal organizer, laptop computer, and so on.

Whatever a storage medium may be, conventional wisdom dictates a person to manually write or type in names of persons, their phone numbers and addresses, and the like. When a person loses or replaces the pocket book, cell phone or organizer, he or she has to write in or type in all information again and again, which is a waste of time and effort, not to mention irritation and frustration involved therewith.

It also happens that a person may engage in a meeting during which he or she is introduced by several or more people and then given as many business cards. In general, it is not easy to remember which card comes from whom. Accordingly, such a person has to keep a separate note to jot down some traits of each person which may be peculiar or which may be easy to remember. Even so, it is not so easy to remember faces of such persons, to distinguish voices and tones thereof, and so on.

Therefore, there is a need for information processing systems and methods therefor which do not require an user to manually input all essential informations thereinto. In addition, there is a strong need for information processing systems and methods therefor which allow the user to synchronize various visual, audible, and text informations according to a format the user may prefer.

### SUMMARY OF THE INVENTION

The present invention generally relates to various information processing systems and related methods arranged to acquire raw images and/or raw sounds through various sensors and detectors, to extract therefrom text information, visual information, and/or audible information, to arrange, modify, edit or otherwise process such informations in order to generate processed images and/or processed sound, and to output such processed images and/or play processed sounds in a preset pattern. More particularly, such information processing systems and methods of this invention may preferably allow users to synchronize different or similar informations which are acquired independently or at different instants. Accordingly, such users may acquire text, visual, and/or audible informations from different sources and/or at different instants, and may arrange, modify, edit or otherwise process one or more of such informations in order to provide more synchronized informations for future references.

The information processing systems of the present invention may be incorporated into various data storage and/or process devices such as, e.g., desktop computers, laptop computers, portable or cellular communication articles such as, e.g., cellular phones, PDAs, personal data organizers, and so on. Such information processing systems may be implemented into such devices during manufacture thereof. Alternatively, such information processing systems may be retrofit into conventional devices.

Various exemplary aspects and/or embodiments of such information processing systems and methods therefor of this invention will now be described, where it is appreciated that such aspects or embodiments may only represent different forms. Such information processing systems and methods therefor of the present invention, however, may also be embodied in many other different forms and, therefore, should not be interpreted to be limiting to the following aspects and/or embodiments which are to be set forth hereinafter. Rather, various exemplary aspects and/or embodiments of information processing systems and methods described hereinafter are provided to make the following disclosure to be thorough and complete, and to fully convey the scope of the present invention to one of ordinary skill in the relevant art.

In one aspect of the invention, an information processing system may be provided to process multiple informations. Such a system may generally include a body, at least one receiving member, at least one control member, and at least one output member, in which all of the above members may be fixedly coupled to the body of the system. More particularly, the receiving member may be disposed in the body and arranged to acquire at least one of a raw image and a raw sound. The control member may be disposed in the body and may be arranged to receive a user command, to operatively couple with the receiving member, and to extract at least one of a text, picture, voice, and music information form the raw image and/or sound. Such a control member may be arranged in various embodiments. For example, the control member may be arranged to process at least one of the informations based the user command and to prepare at least one of a processed image and a processed sound. In the alternative, the control member may be arranged to process at least one of the picture, voice, music, and another text information based on the user command and to prepare at least one of a processed image and a processed sound. The control member may also be arranged to extract a text information from the raw image and/or sound, to extract a picture information from the raw image, to process the text and picture informations based on the user command, and to prepare a processed image. Such a control member may further be arranged to process at least one of the voice, text, music, and another picture information based on the user command and to prepare a processed image and/or sound. The output member may be disposed in the body, coupled to the above control member, and to output the processed image and/or sound. In another embodiment, the receiving member may be disposed in the body and arranged to acquire multiple raw images and the control member may be arranged to extract a first picture information from one of the raw images and a second picture information from another of the raw images, to process the first picture information and second picture informations based on the user command, and to prepare a processed image. The output member may be arranged to output the processed image. In another alternative embodiment, the receiving member is similarly disposed in the body and arranged to acquire analog or digital signals of a raw image and/or sound. The control member may be disposed in the body, arranged to receive a user command, and to operatively couple with the receiving member. Such a control member may be arranged to extract at least one of a text, voice, picture, and/or music information from such signals, to process the text information, to process the music, picture, voice information, and another text information based on the user command, and to prepare the processed image and/or sound. In the alternative, the control member may be arranged to extract a picture information from the signals of the raw image, to extract a text information from the signals of the raw image and/or sound, to process both of the text and picture informations according to the user command, and to prepare the processed image and/or sound. The output member may be disposed in the body, to be coupled to the control member, and arranged to output such a processed image and/or sound.

In another aspect of the present invention, an information processing system may be provided to process multiple informations. The system may also include a body, at least one receiving member, at least one control member, and at least one output member, where such a receiving member may be preferably arranged to acquire raw images or sounds independently or separately from raw sounds or images. More particularly, such a receiving member may be arranged to acquire a raw image and a raw sound at different instants or independently. The control member may be arranged to operatively couple with the receiving member, to receive a user command, and to similarly extract a text, picture, voice, and music information from the raw image and/or sound. Such a control member may then be arranged in various embodiments. For example, the control member may be arranged to process the text information, to process the picture, voice, music, and/or another text information according to the user command, and then to prepare a processed image and/or sound. In the alternative, the control member may be arranged to extract a text information from the raw image and/or sound, to extract a picture information from the raw image, to process the text and picture informations based on the user command, and to prepare a processed image. In another alternative, the control member may also be arranged to process the picture information, to process the voice, music, text, and/or another picture information based on the user command, and to prepare a processed image and/or sound. In addition, the receiving member may be alternatively arranged to acquire multiple raw images independently or at different instants. The control member may be arranged to extract a first picture information from one of the raw images and a second picture information from another of the raw images, to process such first and second picture informations based on the user command, and to prepare a processed image therefrom. The output member may be coupled to the control member and then arranged to output the processed image.

In another aspect of the present invention, an information processing system may be provided to process multiple informations. The system may also include a body, at least one receiving member, at least one control member, and at least one output member, where such a receiving member may be preferably arranged to acquire raw images of texts independently and/or separately from raw images and/or sounds. For example, the receiving member may be arranged to acquire multiple raw images independently or at different instants. The control member may operatively couple with the receiving member and may be arranged to receive a user command, to extract a text information from one of the raw images and a picture information from another of the raw images, to process the text information and picture information based on the user command, and to prepare a processed image. The output member may be arranged to be coupled to the control member and to output the processed image.

In another aspect of the present invention, an information processing system may be provided to process multiple informations. The system may also include a body, at least one receiving member, at least one control member, and at least one output member. The receiving member is disposed in the body and arranged to acquire a raw image of an information card. The control member is arranged to be disposed in the body and to operatively couple with the receiving member. Such a control member may also be arranged to extract a picture information from the raw image of such an information card, to process the picture information, and to prepare a processed image therefrom. The control member may be alternatively arranged to extract a first and second picture information from the raw images of the information card and the person, respectively, to process such informations, and then to prepare at least one processed image therefrom. In another alternative, the control member may be arranged to extract a first and second picture information from the raw images of the information card and the person, respectively, to extract a voice information from the raw sound of the person, to process the picture and voice informations, and then to prepare a processed image and/or sound therefrom. The output member may be disposed in the body and arranged to be coupled to the control member and to output the processed image in synchronization with the processed sound.

In another aspect of the present invention, an information processing system may be provided to process multiple informations. The system may also include a body, at least one receiving member, at least one control member, and at least one output member. The receiving member is disposed in the body and arranged to acquire a raw image of an information card. The control member is arranged to be disposed in the body and to operatively couple with the receiving member. Such a control member may be arranged to extract a text and/or picture information from such a raw image of the information card, to process the picture information, and to prepare a processed image therefrom. Such a control member may also be arranged to extract a text and/or a first picture information from the raw image of the information card, to extract a second picture information from the raw image of the person, then to process the text and picture informations, and to prepare at least one processed image therefrom. In another alternative, the control member may further be arranged to extract a text and/or a first picture information from the raw image of the information card, to extract another second picture information from the raw image of the person, to extract a voice information from the raw sound of the person, to process each of the text, picture, and voice informations, and then to prepare a processed image and a processed sound therefrom. The output member may also be disposed in the body and arranged to be coupled to the control member and to output such a processed image in synchronization with the processed sound.

In another aspect of the present invention, an information processing system may be provided to process multiple informations. The system may also include a body, at least one receiving member, at least one control member, and at least one output member. The receiving member is disposed in the body and arranged to directly acquire a text information. The control member may be arranged to be disposed in the body and to operatively couple with the receiving member. The control member may also be arranged to process the text information and to prepare a processed image therefrom. In the alternative, the control member may be arranged to extract at least one picture information from such a raw image of the person, to process the text and picture informations, and then to prepare at least one processed image therefrom. The control member may be arranged to extract at least one picture information from the raw image of the person, to extract at least one voice information from the raw sound of the person, to process the voice, picture, and text informations, and to prepare a processed image as well as a processed sound therefrom. The output member may be disposed in the body and arranged to be coupled to the control member and to output the processed image in synchronization with the processed sound.

Embodiments of the foregoing aspects of the present invention may include one or more of the following features.

As described above, all members of the foregoing exemplary information processing systems may be fixedly disposed inside and/or on the body thereof, while minimal portions thereof may also be exposed through such a body. Alternatively, at least a portion of the receiving member and/or output member may be detachably coupled to the rest of the systems so that the user may attach and detach such a portion. The receiving member may be arranged to receive different inputs in different modes, e.g., acquiring the raw image and the raw sound independently and/or at different instants, acquiring a first raw image and a second raw image independently and/or at different instants, and so on. The output member may be arranged to output multiple processed images simultaneously or sequentially. Alternatively, the output member may be arranged to output multiple processed sounds simultaneously or sequentially or to output the processed image and sound synchronously, in a spatially related mode or in a temporally related mode. In addition, a sensing area of the receiving member may be arranged to be not substantially larger than a size of an information card. The control member may be arranged to edit (e.g., create, add, delete, copy, and/or paste) at least a portion of the raw image and/or sound and/or to modify (e.g., reshape, resize, recolor, and/or rearrange) at least a portion of the raw image and/or sound.

In another aspect of this invention, a variety of methods may be provided to process different types of informations by various information processing devices. Such devices may also be provided by a variety of methods. Such a method may include the steps of acquiring a raw image and/or a raw sound independently or at different instants, extracting at least one of a text, picture, voice, and music information therefrom, processing at least one of said different informations, preparing a processed image and/or sound by the above processing step, and outputting the processed image and/or sound. Another method may include the steps of acquiring a raw image and/or a raw sound independently or at different instants, extracting text, picture, voice, and/or music informations therefrom, processing the text information, processing the picture, voice, music, and/or another text information, preparing a processed image and/or sound by the foregoing processing step, and outputting the processed image and/or said processed sound. An alternative method may include the steps of acquiring a raw image and/or a raw sound independently or at different instants, extracting a text information from the raw image and/or sound, extracting a picture information again from the raw image, processing such text and picture informations, preparing a processed image by the above processing step, and outputting said processed image. Another method may also include the steps of acquiring a raw image and/or a raw sound independently or at different instants, extracting at least one of a text, picture, voice, and music information therefrom, processing the picture information, processing at least one of the voice, text, music, and another picture information, preparing a processed image and/or sound by the above processing step, and outputting the processed image and/or sound. Another alternative method may also include the steps of acquiring a plurality of raw images, extracting a first and a second picture information from different raw images, processing the first and second picture informations, preparing a processed image by the above processing step, and outputting the processed image. A yet another method may further include the steps of acquiring analog and/or digital signals of a raw image and/or sound independently or at different instants, extracting a text, picture, voice, and/or music information therefrom, processing the text information, processing the picture, voice, music, and/or another text information, preparing a processed image and/or sound by the above processing step, and outputting such a processed image. Another method may further include the steps of acquiring analog and/or digital signals of a raw image and/or sound independently or at different instants, extracting a picture information from such signals, extracting a text information from such signals, processing both of the text and picture informations, preparing a processed image and/or sound by such a processing step, and outputting the processed image and/or sound.

In yet another aspect of this invention, further methods may be provided to process different types of informations by various information processing devices and such devices may be provided by a variety of methods as well. More particularly, these methods are characterized by acquiring and displaying picture informations. Such a method may include the steps of acquiring a raw image of an information card, extracting a picture information from each of the raw images, preparing a processed image including thereon at least one of such picture informations, and then outputting said processed image. A similar method may also include the steps of acquiring a raw image of an information card, extracting a picture information from each of said raw images, preparing a processed image including thereon a plurality of such picture informations which are disposed in a preset pattern, and outputting the processed image thereafter. Another method may include the steps of acquiring a first raw image of an information card and a second raw image of a person who is displayed or otherwise related to the information card, extracting a first picture information from said first raw image, also extracting a second picture information from the second image, preparing a processed image including such a first and second picture information disposed in a preset pattern, and outputting the processed image. An alternative method may further include the steps of acquiring a first raw image of an information card, a second raw image of a person displayed by or related to the information card, and a raw sound of a voice of the person, extracting a first picture information from the first raw image, extracting a second picture information from the second image, extracting a voice information from the raw sound as well, preparing a processed image including thereon the first and second picture informations as well as a processed sound from the raw sound, and outputting the processed image in synchronization with or in relation to the processed sound.

In yet another aspect of this invention, further methods may be provided to process different types of informations by various information processing devices and such devices may be provided by a variety of methods as well. More particularly, these methods are characterized by acquiring text informations from raw images and displaying such text informations alone or in conjunction with other extract informations. Such a method may include the steps of acquiring a raw image of an information card, extracting a text information from such a raw image, preparing therefrom a processed image of the text information, and then outputting the processed image. Another method may include the steps of acquiring a raw image of an information card, extracting a text information from each of such raw images, preparing a processed image which includes thereon multiple text informations of multiple raw images disposed in a preset pattern, and outputting such a processed image. An alternative method may include the steps of acquiring a first raw image of an information card and a second raw image of a person represented by or otherwise related to the information card, extracting a text information from the first raw image, also extracting a picture information from the second raw image, preparing a processed image including thereon the text and picture informations arranged in a preset pattern, and outputting the processed image. Another method may include the steps of acquiring a first raw image of an information card, a second raw image of a person represented by or related to the information card, and a raw sound of a voice of the person, extracting a text information from the first raw image, extracting a picture information from the second image, additionally extracting a voice information from the raw sound, preparing a processed image including said text and picture informations thereon and a processed sound from the raw sound, and outputting the processed image in synchronization with or in relation to the processed sound.

Embodiments of this aspect of the invention may include one or more of the following features.

The acquiring step may include the step of disposing all members of the information processing system fixedly to a body of the system or detachably disposing at least a portion of such members to the body of the system. The acquiring step may also include the step of receiving a raw image and a raw sound independently or at different instants. Alternatively, the acquiring step may rather include the step of receiving a first raw image and a second raw image independently or at different instants. The outputting step may also include the step of displaying multiple processed images simultaneously or sequentially and/or playing multiple processed sounds simultaneously or sequentially. In addition, the outputting step may include the step of outputting the processed image and sound synchronously or in otherwise related pattern. The processing step may include at least one of the steps of creating, deleting, adding, copying, and pasting at least a portion of the raw image and/or the raw sound. The processing step may further include at least one of the steps of reshaping, resizing, recoloring, and rearranging at least a portion of the raw image and/or sound.

As used herein, an “information” refers to one or more of a “text information” (which is to be abbreviated as “t-info” hereinafter), a “picture information” (to be abbreviated as “p-info” hereinafter), a “voice information” (to be abbreviated as “v-info” hereinafter), a “music information” (abbreviated as “m-info” hereinafter), and the like. The “t-info” refers to a combination of alphanumerals, characters of other languages, and/or symbols which may or may not convey any meaning. Detailed shapes, sizes, and/or colors of the alphanumerals, characters, and/or symbols may not be material to the meaning of such a t-info, unless a shape, size, and/or color of only a portion of such alphanumerals, characters, and/or symbols may be arranged to differ from the shapes, colors, and/or sizes of the rest thereof to draw attention thereto. The “p-info” refers to an aggregate of black-grey-white dots and/or color dots which may represent a look of a person, an object, an abstract configuration, and the like. Therefore, detailed shapes, sizes, colors, and/or arrangements of such dots may generally be material to such a p-info. The “v-info” refers to one or more characteristics of audible and/or inaudible acoustic waves generated by vibration of a medium such as, e.g., air. Examples of the characteristics of such waves may include, but not be limited to, a number of harmonics constituting the waves, a frequency of each harmonic, a phase angle of each harmonic, an intensity of each harmonic, and so on, all of which may contribute to imparting a unique feature to such waves. Accordingly, detailed shapes of each of such harmonics may be the most prominent of the wave characteristics. An overall intensity of the waves, however, is generally not material to the v-info, unless an intensity of only a portion of the waves may be arranged to differ from that of the rest of the waves or unless the overall intensity is substantially greater or less than other waves. All audible or inaudible waves originating from a person, an animal, a musical instrument, and an object have their own characteristics. Therefore, the v-info is deemed to apply to all such waves. To the contrary, the “m-info” refers to one or more musical characteristics of the acoustic waves such as, e.g., a pitch and/or a tone of a musical note, its duration, an arrangement of such notes, and the like. The harmonic characteristics of such acoustic waves, however, may not be as important as those of the m-info and, therefore, the m-info is different from the v-info.

In addition and as used herein, an “input” generally refers to at least one of a “raw image” and a “raw sound” each of which may include at least one of the foregoing informations such as, e.g., the t-info, p-info, v-info, and m-info. Examples of the raw images may include, but not be limited to, still or dynamic images provided on a printed medium such as, e.g., business cards, documents, address or phone books, brochures, and so on, still or dynamic images of objects, those of persons, and the like. More particularly, the raw image provided on a printed medium may include the t-info and/or p-info, the image of any object may similarly include the t-info and/or p-info thereon, while the image of a person may typically include only the p-info such as, e.g., visual characteristics of his or her face, hair, blood vessels on a retina, a finger print, and the like. Examples of such raw sounds may include, but not be limited to, conversations, (vocal) songs, (instrumental) musics, background noises, and the like. More particularly, the raw sound of a conversation may typically include the t-info and v-info, whereas that of a song may include the m-info in addition to the t-info and the v-info. The sound of an instrumental music may generally include the m-info and v-info, whereas that of the background noises may only include the v-info. Such an “input” may further include various informations previously stored in other media or information processing devices, examples of which may include, but not be limited to, DVDs, CDs, hard and/or floppy disks, magnetic tapes, microchips, magnetic stripes, optical disks, stationary devices such as desktop computers, portable devices including laptop computers, cell phones, PDAs, data organizers, palm devices, other storage media arranged to store analog and/or digital data, other devices arranged to process analog and/or digital data, and the like, where the input may include one or more of the foregoing t-info, p-info, v-info, and m-info. Such an “input” may further include various informations stored in networks such as local networks, municipal networks, worldwide webs, and various informations of contents of such networks, e-mails, and the like, where the input may include one or more of the foregoing t-info, p-info, v-info, and m-info. Furthermore, the “input” may include all of such informations stored in another information processing system of this invention.

Unless otherwise defined in the following specification, all technical and scientific terms used herein have the same meaning as commonly understood by one of ordinary skill in the art to which the present invention belongs. Although the methods or materials equivalent or similar to those described herein can be used in the practice or in the testing of the present invention, the suitable methods and materials are described below. All publications, patent applications, patents, and/or other references mentioned herein are incorporated by reference in their entirety. In case of any conflict, the present specification, including definitions, will control. In addition, the materials, methods, and examples are illustrative only and not intended to be limiting.

Other features and advantages of the present invention will be apparent from the following detailed description, and from the claims.

### BRIEF DESCRIPTION OF THE DRAWINGS

FIG. 1A is a block diagram of various exemplary functional members included in an exemplary information processing system according to the present invention;

FIG. 1B is a perspective view of various exemplary functional units for the functional members of the exemplary information processing system of FIG. 1A according to of the present invention;

FIG. 2A is a schematic diagram of an exemplary scanner unit similar to a conventional copier or a conventional scanner according to the present invention;

FIG. 2B is a schematic diagram of another exemplary scanner unit with a scanning head which is fixedly coupled to a top of a body according to the present invention;

FIG. 2C is a schematic diagram of another exemplary scanner unit with a scanning head which is fixedly coupled to an edge of a body according to the present invention;

FIG. 2D is a schematic diagram of another exemplary scanner unit with a scanning head which moves away from and toward a body according to the present invention;

FIG. 2E is a schematic diagram of another exemplary scanner unit with a scanning head which slides or translates over a body according to the present invention;

FIG. 2F is a schematic diagram of another exemplary scanner unit with a scanning head which rotates over a body according to the present invention;

FIG. 3A is a schematic diagram of a cell phone incorporating therein an exemplary information processing system according to the present invention;

FIG. 3B is a schematic diagram of another cell phone incorporating therein another exemplary information processing system according to the present invention;

FIG. 3C is a schematic diagram of a laptop computer incorporating therein another exemplary information processing system according to the present invention;

FIG. 4A is a top view of an exemplary raw image of a conventional business card;

FIG. 4B is a schematic view of an exemplary processed image of stacked raw images of FIG. 4A according to the present invention;

FIG. 4C is a schematic view of another exemplary processed image of informations extracted from the raw image of FIG. 4A and other raw images according to the present invention; and

FIG. 4D is another schematic view of the exemplary processed image of informations shown in FIG. 4C with one of its functions selected according to the present invention.

### DETAILED DESCRIPTION OF THE PREFERRED EMBODIMENTS

The present invention generally relates to various information processing systems and related methods to acquire one or more inputs such as, e.g., raw images, raw sounds, and the like, to extract therefrom one or more informations such as, e.g., a “text information,” a “picture information,” a “voice information,” and a music information,” (to be abbreviated as a “t-info,” a “p-info,” a “v-info,” and a “m-info” hereinafter, respectively), and to process (such as e.g., to arrange, to edit, to modify, and/or to rearrange) one or more of such informations and obtain one or more outputs such as, e.g., processed images, processed sound, and the like, and to output one or more of such processed images and/or processed sounds based on a preset pattern. More particularly, the information processing systems and methods therefor of this invention may preferably allow users to synchronize different or similar informations which may be contained in various inputs and which may be acquired independently or at different instants. Therefore, the users may acquire visual informations (such as, e.g., text and/or picture informations) and/or audible informations (such as, e.g., voice and/or music informations) from different sources and/or at different instants, and may edit, modify, rearrange or otherwise process such informations in order to generate the outputs which may be more synchronized and/or formatted according to preset patterns for future references. In addition, such information processing systems of this invention may

The information processing systems of the present invention may be incorporated into various data storage and/or process devices such as, e.g., desktop computers, laptop computers, portable or cellular communication articles such as, e.g., cellular phones, PDAs, personal data organizers, and so on. Such information processing systems may be implemented into such devices during manufacture thereof. Alternatively, such information processing systems may be retrofit into conventional devices.

It is appreciated that an “information” as used herein refers to one of the “text information” (or “t-info”), “picture information” (or “p-info”), “voice information” (or “v-info”), “music information” (or “m-info”), and the like. The “t-info” typically refers to a combination of alphanumerals, characters of other languages, symbols which may or may not convey any meaning, and the like. Detailed shapes, sizes, and/or colors of the alphanumerals, characters, and/or symbols may not be material to the meaning of the t-info, unless a shape, size, and/or color of a portion of such alphanumerals, characters, and/or symbols may be arranged to differ from the shapes, colors, and/or sizes of the rest thereof so as to draw attention thereto. The “p-info” refers to an aggregate of black-grey-white dots and/or color dots which may represent a look of a person, an object, an abstract configuration, and the like. Therefore, detailed shapes, sizes, colors, and/or arrangements of such dots may generally be material to such a p-info. The “v-info” refers to one or more characteristics of audible and/or inaudible acoustic waves generated by vibration of a medium such as, e.g., air. Examples of the characteristics of such waves may include, but not be limited to, a number of harmonics constituting the waves, a frequency of each harmonic, a phase angle of each harmonic, an intensity of each harmonic, and so on, all of which may contribute to imparting a unique feature to such waves. Accordingly, detailed shapes of each of such harmonics may be the most prominent of the wave characteristics. An overall intensity of the waves, however, is generally not material to the v-info, unless an intensity of only a portion of the waves may be arranged to differ from that of the rest of the waves or unless the overall intensity is substantially greater or less than other waves. All audible or inaudible waves originating from a person, an animal, a musical instrument, and an object have their own characteristics. Therefore, the v-info is deemed to apply to all such waves. To the contrary, the “m-info” refers to one or more musical characteristics of the acoustic waves such as, e.g., a pitch and/or tone of a musical note, its duration, an arrangement of such notes, and the like. The harmonic characteristics of the waves, however, may not be material to the m-info and, therefore, the m-info is different from the v-info.

It is also appreciated that an “input” as used herein refers to one or both of a “raw image” and a “raw sound” each of which may include at least one of the foregoing informations such as, e.g., the t-info, p-info, v-info, and m-info. Examples of the raw images may include, but not be limited to, still or dynamic images provided on a printed medium such as, e.g., business cards, documents, address or phone books, brochures, and so on, still or dynamic images of objects, those of persons, and the like. More particularly, the raw image provided on a printed medium may include the t-info and/or p-info, the image of any object may similarly include the t-info and/or p-info thereon, while the image of a person may typically include only the p-info such as, e.g., visual characteristics of his or her face, hair, blood vessels on a retina, a finger print, and the like. Examples of such raw sounds may include, but not be limited to, conversations, (vocal) songs, (instrumental) musics, background noises, and the like. More particularly, the raw sound of a conversation may typically include the t-info and v-info, whereas that of a song may include the m-info in addition to the t-info and the v-info. The sound of an instrumental music may generally include the m-info and v-info, whereas that of the background noises may only include the v-info. Such an “input” may further include various informations previously stored in other media or information processing devices, examples of which may include, but not be limited to, DVDs, CDs, hard and/or floppy disks, magnetic tapes, microchips, magnetic stripes, optical disks, stationary devices such as desktop computers, portable devices including laptop computers, cell phones, PDAs, data organizers, palm devices, other storage media arranged to store analog and/or digital data, other devices arranged to process analog and/or digital data, and the like, where the input may include one or more of the foregoing t-info, p-info, v-info, and m-info. Such an “input” may further include various informations stored in networks such as local networks, municipal networks, worldwide webs, and various informations of contents of such networks, e-mails, and the like, where the input may include one or more of the foregoing t-info, p-info, v-info, and m-info. Furthermore, the “input” may include all of such informations stored in another information processing system of this invention.

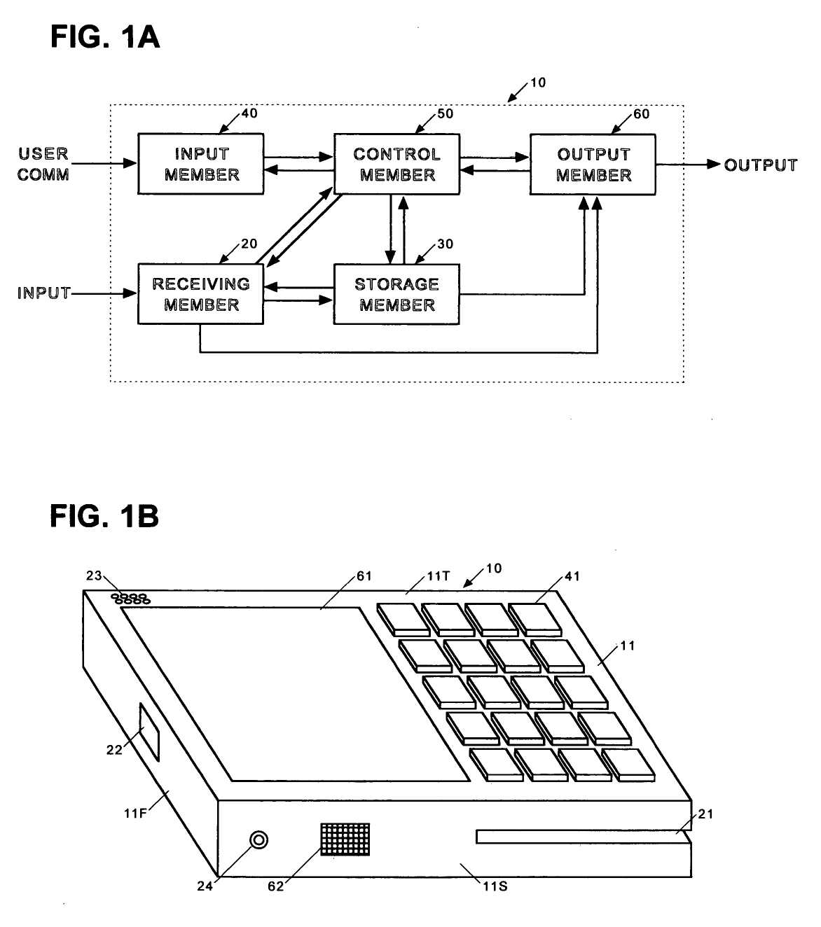

In one aspect of the present invention, an information processing system includes at least one receiving member, at least one storage member, at least one input member, a control member, and at least one output member. FIG. 1A denotes a block diagram of various exemplary functional members included in an exemplary information processing system and FIG. 1B is a perspective view of various exemplary functional units for the functional members of the exemplary information processing system of FIG. 1A according to of the present invention. As exemplified in FIG. 1A, an exemplary information processing system 10 typically include a receiving member 20, a storage member 30, an input member 40, a controller 50, and an output member 60.

The receiving member 20 is generally arranged to receive or to acquire various inputs such as, e.g., images of text, images of persons, images of objects, voices of such persons, sounds of such objects, sounds from musical instruments, background noises, and the like. To differentiate different kinds of such images, voices, and/or sounds, “raw” images and/or “raw” sounds as used herein will refer to those images and/or sounds which are acquired or which are to be acquired by the receiving member 20, while “processed” images and/or “process” sounds refer to those images and/or sounds which have been processed by the control member 50 of the system 10 and may be outputted by the output member 60 of the system 10 selectively in a preset pattern. Such “processed” images and/or sounds may generally be different from and more synchronized than the “raw” images and/or sounds, although the system 10 may be arranged to output the raw images and/or raw sounds without editing or modifying such. Accordingly, such processed images and/or sounds may be identical to those raw images and/or sounds in some occasions.

Still referring to FIGS. 1A and 1B, the storage member 30 is generally arranged to permanently and/or temporarily store therein the raw images and/or sounds acquired by the receiving member 20, the processed images and/or sounds generated by such a control member 50, interim images and/or sounds generated by the control member 50 during processing of the raw images and/or sounds, and the like. The storage member 30 may be operationally arranged to receive such images and/or sounds from other members of the system 10 and to send such images and/or sounds stored therein to other members of the system 10. Accordingly, the storage member 30 may be operatively coupled to other members of the system 10 such as, e.g., the receiving member 20, control member 50, and/or output member 60.

The input member 40 is arranged to receive tactile or vocal user commands. For example, the input member 40 may include at least one keyboard, keypad, stylus pad, keys, and/or buttons capable of receiving alphanumeric and/or character commands from an user. Alternatively, the input member 40 may include a conventional touch pad, joystick, pointing stick, pointing rod, and other cursor control devices capable of moving a pointer or cursor across a display screen (such as, e.g., a video output unit 61 of FIG. 1B). In addition, the input member 40 may also include a voice recognition unit capable of receiving and/or extracting an user command which is contained in the voice of the user. Such an input member 40 may preferably be operatively coupled to the control member 50 in order to relay the user command thereto.

The control member 50 is operatively coupled to all other members 2040, 60 of the system 10 to control detailed operations thereof. For example, the control member 50 may arrange the receiving member 20 to acquire specific raw images and/or sounds through one or more of its receiving units, process such raw images and/or sounds, prepare therefrom such processed images and/or sounds, manipulate the storage member 30 to store one or more of such raw and/or processed images and/or sounds, and control the output member 60 to output the processed images and/or sounds in a preset pattern through one or more of its output units. To these ends, the control member 50 may preferably be arranged to determine, based upon the user command, whether to store such raw images and/or sounds in the storage member 30, whether to fetch the raw and/or interim images and/or sounds from the storage member 30 in preparing such processed images and/or sounds, whether to edit, modify, and/or rearrange such raw images and/or sounds, in which format and with which unit to output such processed images and/or sounds, and so on. The control member 50 may also be arranged to be able to communicate with other data storage and/or processing devices, either through wire or wirelessly, in order to receive and/or send various informations. Such a control member 50 may also be arranged to perform other functions as will be described in greater detail below.

The output member 60 is arranged to output the processed images and/or sounds according to a preset pattern which is to be at least partly determined by the user command. Therefore, the output member 60 may be arranged to display the processed image according to a preset pattern, to display multiple processed images in a preset order, to display multiple processed images sequentially and/or simultaneously, and the like. The output member 60 may also play the processed sounds according to a preset pattern. When desirable, the output member may also be arranged to display the processed image while playing the processed sound which may be synchronized to those processed images or which may be independent of those processed images.

In operation, the user selects the raw images and/or sounds which are to be acquire with the information processing system 10. For example, the user manipulates one or more video input units of such a receiving member 20 when the input is the raw images, and may manipulate one or more audio input units of the receiving member 20 when the input is the raw sounds. The user also provides one or more user input commands to the input member 40 and provides guidance to the control member 50 which may then receive the raw images and/or sounds acquired by the receiving member 20, with or without saving one or more of such raw images and/or sounds in the storage member 30. Based on such commands, the control member 50 processes the raw images and/or sounds, generates interim images and/or sounds, and then generates the processed images and/or sounds. The output member 50 receives the raw and/or processed images and/or sounds and, based upon such input commands, displays such images and/or plays such sounds in a preset pattern and/or preset sequence.

Illustrated in FIG. 1B are exemplary units of the foregoing members exposed on the exemplary information processing system 10 which has a body 11 forming a top 11T, a bottom (not shown in the figure), a front 11F, a back (not shown in the figure), and sides 11S. The receiving member 20 has a variety of different receiving units such as a scanner unit 21, a video input unit 22, and an audio input unit 23. The scanner unit 21 is disposed on one side of the system 10 to scan or capture the images of small pieces of printed media such as, e.g., business cards. More particularly, the scanner unit 21 of FIG. 1B includes a fixed scanning head (not shown in the figure) and defines a narrow slit through which the user manually moves the printed media with respect to the stationary scanning head. The video input unit 22 is disposed in one end of the system 10 and captures the raw images of persons and/or objects disposed in front thereof. Any conventional lens-CCD assemblies used in camcorders and digital cameras may be used as the video input unit 22. The audio input unit 23 is disposed on the top 11T of the system 10 to capture the raw sounds propagating through a surrounding medium. The input member 40 include a keypad 41 exposed on the top 11T of the system 10 such that the user may input various commands therethrough. Similar to the receiving member 20, the output member 60 also includes different output units such as, e.g., a video output unit 61 which is disposed over the top 11T of the system 10 to display the raw, interim, and/or processed images thereon, an audio output unit 62 which is disposed on the side 11S of the system 10 so as to play the raw, interim, and/or processed sounds, and the like. It is to be understood that the storage member 30 and/or control member 50 may be disposed inside the body 11 and, therefore, not shown in the figure in this exemplary embodiment.

In operation and, more particularly, in a situation when a user meets an unacquainted person, receives his or her business card, has business conversation, and makes appointments for calls and meetings, the information processing system 10 of the present invention allows the user to arrange all different informations and synchronize them for better future references. For example, the user may manually swipe the person's business card through the slit of the scanner unit 21 which may acquire the raw image of the business card therefrom and then send the raw image to the control member 50. Independently of the scanning operation, the user may capture the still and/or dynamic raw images of the person by the video input unit 22 and then send such images to the control member 50. The user may also acquire the raw sounds of conversation through audio input unit 23 either simultaneously or independently of the other scanning and/or capturing operations and may send such raw sounds to the control member 50.

The control member 50 may be arranged to extract a first t-info, e.g., by recognizing various alphanumerals and/or characters in the raw images of the business card, to extract a second t-info, e.g., by analyzing the raw sounds of the conversation and recognizing contents thereof, to extract a third t-info, e.g., by recognizing various alphanumerals and/or characters in the raw images of various objects and/o background, to extract a fourth info, e.g., by analyzing other text informations stored in the storage member 30 and/or external text information imported by other storage and/or processing devices, and the like. Such a control member 50 may then rearrange, edit, and/or modify the foregoing extracted t-infos, e.g., by rearranging, adding or deleting certain features thereof, by copying, pasting, and/or superimposing one extracted t-info onto another extracted t-info, by copying, pasting, and/or superimposing other t-infos stored in the storage member 30 and/or imported from external devices on or over the extracted t-info, by changing shapes (i.e., fonts), sizes, colors, and/or arrangements of the alphanumerals and/or characters, and so on. The control member 50 may store such t-infos in the storage member 30 for later use, may display such t-infos with various units of the output member 60, may use the t-infos to search therefrom specific informations such as, e.g., names, phone numbers, addresses, may utilize such t-infos so as to find a resemblance and/or discrepancy between multiple t-infos, and so on. The control member 50 may also be arranged to display the extracted t-infos while displaying other t-infos regarding the same and/or different person and/or object, while displaying the p-infos of the same and/or different person and/or object, while playing the v-infos of the same and/or different person, playing the m-infos, and the like.

The control member 50 may be arranged to extract a first p-info, e.g., by recognizing person's appearances from the still or dynamic raw images of the person directly acquired from such a person or indirectly acquired from a still picture or video clip of the person, to extract a second p-info, e.g., by recognizing an insignia or a logo of a company the person works for, to extract a third p-info, e.g., by recognizing appearances of an object and/or a background, and the like. The control member 50 may also be arranged to rearrange, edit, and/or modify the above p-infos, e.g., by selecting the best frontal image of the person from his or her multiple raw images, by selecting only a portion of interest of such raw images, by enlarging or shrinking the above p-infos to fit them into a standard size predetermined by the system 10, and the like. The control member 50 may store such p-infos in the storage member 30 for later use, may display such p-infos on various units of the output member 60, may use such p-infos to search therefrom specific informations such as, e.g., names, addresses, phone numbers, and the like, may use such p-infos to identify a resemblance and/or discrepancy between multiple p-infos, and the like. Such a control member 50 may also be arranged to display such extracted p-infos while displaying other p-infos of the same and/or different person and/or object, while displaying the t-infos of the same and/or different person and/or object, playing the v-infos of the same or different person, while playing the m-infos, and the like.

The control member 50 may be arranged to extract a first v-info, e.g., by analyzing a person's voice directly acquired from such a person, to extract a second v-info, e.g., by analyzing a recording of the voice of such a person, to extract a third v-info, e.g., by acquiring harmonic data of the person, and so on. The control member 50 may also store the v-infos in the storage member 30 for later use, may play such v-infos using various units of the output member 60, may use such v-infos to identify a person calling or leaving a message in an answering machine and/or voice mailbox, may utilize the v-infos to extract a portion of a speech made by a specific person from a recording of a conversation, a meeting, and the like. Such a control member 50 may also be arranged to play such extracted v-infos while playing other v-infos of the same and/or different person, while displaying the t-infos regarding the same and/or different person, while displaying the t-infos of the objects, playing the p-infos of the same and/or different person, while playing the p-infos of the object, playing the m-infos, and the like.

The control member 50 may be arranged to extract various m-infos, e.g., by analyzing musics of various instruments and/or songs of a person either directly acquired from such an instrument or a person or indirectly acquired from a recording or other devices, and so on. Such a control member 50 may store the m-infos in the storage member 30 for later use, may play the m-infos using various units of the output member 60, and so on the control member 50 may be arranged to play the extracted m-infos while playing other m-infos regarding the same and/or different person and/or instruments, while displaying the t-infos regarding the same and/or different person and/or instruments, while displaying the p-infos of the same and/or different person and/or instruments, while playing the v-infos regarding the same and/or different person, and the like.

The information processing systems of the present invention may be constructed as separate systems as exemplified in FIG. 1B. Alternatively, such information processing systems of the present invention may be incorporated into conventional electric or electronic, digital or analog data processing devices or, in another alternative, may include various functions of such conventional data processing devices. It is to be understood that the latter embodiments may offer benefits that various input and/or output units of such conventional devices may be utilized as various input and/or output units of such receiving, input, and/or output members of the information processing systems of this invention and, in addition, that various storage units of such devices may also be utilized as the storage member of the information processing systems of this invention.

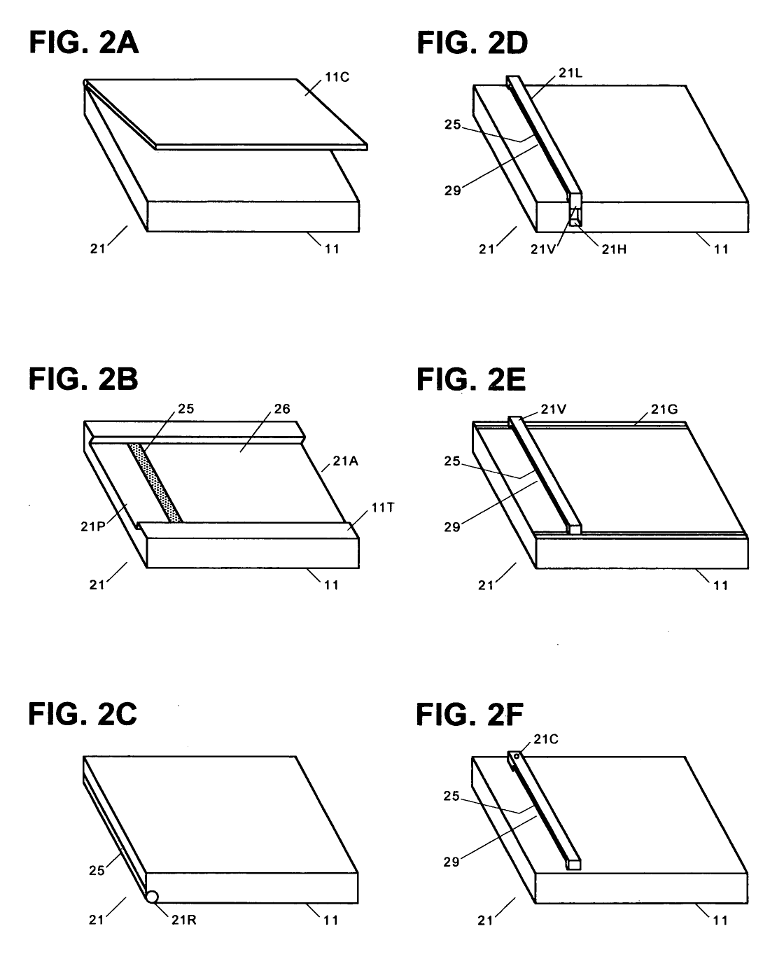

In another aspect of the present invention, such information processing systems may employ various scanning units capable of capturing raw images from various articles such as, e.g., business cards, which may be disposed within a preset distance, e.g., 10 inches, 5 inches, 3 inches, 2 inches, 1 inch, 0.5 inch or less. Following FIGS. 2A through 2K exemplify various scanning units with which the user may capture such raw images from such articles. It is to be understood, however, that such exemplary embodiments are intended to illustrate and not to limit the scope of the present invention. It is also appreciated that various scanning units of the following figures may be implemented into almost any part of the information processing system and, therefore, that the following figures only represent only portions of such an information processing system.

One exemplary embodiment of such a scanning unit is shown in FIG. 2A which is a schematic diagram of an exemplary scanner unit which is similar to a conventional copier and/or a conventional scanner according to the present invention. A scanner unit 21 includes a scanning head (not shown in the figure) and a pivoting cover 11C which is capable of covering and uncovering the scanner unit 21. It is to be understood that such a scanner unit 21 may employ various scanning mechanisms such as, e.g., a translating or sliding scanning head similar to that of a conventional copier or scanner.

In operation, the cover 11C is typically disposed over the scanner unit 21 when not in use. An user may pivot the cover 11C away from the body 11, place an article such as a business card over the scanner unit 21, and manipulates its scanning head to capture various visual informations such as the t-infos and/or p-infos. Thereafter, the user opens the cover 11C, removes the article therefrom, and covers the scanner unit 21.

Another exemplary embodiment of such a scanning unit is described in FIG. 2B which shows a schematic diagram of another exemplary scanner unit with a scanning head fixedly coupled to a top of a body according to the present invention. A scanner unit 21 is disposed in a portion of a body 11 which is arranged to form a recessed area 26, where a scanning head 25 of the scanner unit 21 may be fixedly provided thereacross. In addition, a height of the recessed area 26 is arranged to be wider than a height of an aperture 21A formed on a top 11T of the body 11. More particularly, such a height of the recessed area 26 is arranged to match and/or to be slightly bigger than a height of conventional business cards but that the height of the aperture 21A may be arranged to be slightly smaller than that of the cards such that the business cards may be inserted through a space 21P defined between the recessed area 26 and aperture 21A and movably retained therein.

In operation, an user inserts one end of the article through the space 21P and advances such an article toward the scanning head 25. As the article moves through the scanning head 25, various visual informations such as the t-infos and/or p-infos of the article are scanned by the scanning head 25. When an opposite end of the article is swiped by such a scanning head 25, a scanning operation is completed. In general, the user may move the article over the scanning head 25 at any speed, and the scanning head 25 may be arranged to scan such an article at a preset sampling rate and/or as the article moves thereacross. When desirable, the scanner unit 21 may be arranged to incorporate one or more transporting mechanisms (not shown in the figure), and to move the article over the scanning head 25 at a preset speed.

Another exemplary embodiment of such a scanning unit is described in FIG. 2C which shows a schematic diagram of another exemplary scanner unit with a scanning head fixedly disposed on an edge of a body according to the present invention. A scanner unit 21 is disposed near one edge of a body 11 while exposing its scanning head 25 which is fixedly disposed along at least a portion of the edge of the body 11. The scanner unit 21 also includes at least one roller 21R along such an edge of the body 11 and, more particularly, such a roller 21R may have a diameter which may be large enough to provide a gap between the scanning head 25 and an article such as a business or document when the scanner unit 21 is disposed thereover.

In operation, an user places the scanner unit 21 over the article while movably supporting the entire scanner unit 21 by the roller 21R. The user may translate or slide the scanner unit 21 with the roller 21R over the article along a preset direction, while the scanning head 25 of the scanning unit 21 may scan the article during such translating and/or sliding movement of the article. Because the roller 21R has dimension big enough to float the scanning head 25 over the article, such a scanning head 25 may capture various visual informations such as, e.g., the t-infos and/or p-infos of the article during the translating and/or sliding movement of the scanner unit 21.

Another exemplary embodiment of such a scanning unit is described in FIG. 2D which show a schematic diagram of another exemplary scanner unit with a scanning head which moves away from and toward a body according to the present invention. Such a scanner unit 21 includes a longitudinal support 21L and a pair of vertical supports 21S, where the longitudinal support 21L extends across a height (or length) of a body 11, while the vertical supports 21V are disposed on opposing ends of the longitudinal support 21L and arranged to extend vertically therefrom. A scanning head of the scanner unit 21 is implemented along a preset length of a lower surface of such a longitudinal support 21L and, therefore, not shown in the figure. A body 11 also forms on its opposing sides a pair of housings 21H which are arranged to receive at least a portion of the vertical supports 21V therein. In addition, such vertical supports 21V are arranged to move upwardly and downwardly along the housings 21H such that such horizontal supports 21H may be disposed on or immediately over the body 11 as the vertical supports 21V translate downward and that the horizontal supports 21H are separated from the body 11 by a preset distance and define a slit 29 as the vertical supports 21V translate upward.

In operation, the scanner unit 21 is kept in its rest position as the vertical supports 21V move downwardly and the horizontal supports 21H are disposed on or closer to the body 11. An user may then pull the horizontal supports 21H upwardly and/or move the vertical supports 21H upwardly so as to define the slit 29 between the scanning head and body. The user may insert one end of the article through the slit 29 and advance such an article across the scanning head which may capture various visual informations such as the t-infos and/or p-infos of the article. As an opposite end of the article is swiped by such a scanning head, a scanning operation is completed. Similar to the embodiment of FIG. 2B, the user may move the article below the scanning head at any speed, and the scanning head may be arranged to scan the article at a preset sampling rate and/or as the article moves thereacross. When desirable, the scanner unit 21 may be arranged to include one or more transporting mechanisms (not shown in the figure), and to move the article over the scanning head 25 at a preset speed. When the scanning operation is over, the user pushes down the horizontal and/or vertical support 21H, 21V and get the scanner unit 21 ready for a next scanning operation.

Another exemplary embodiment of such a scanning unit is described in FIG. 2E which shows a schematic diagram of another exemplary scanner unit including a scanning head translating or sliding over a body according to the present invention. Similar to that of FIG. 2D, a scanner unit 21 includes a longitudinal support 21L extending across a height (or length) of a body 11 as well as a pair of vertical supports 21S on opposing ends of the longitudinal support 21L and extending vertically therefrom. A scanning head of the scanner unit 21 is similarly implemented along a preset length of a lower surface of such a longitudinal support 21L and, therefore, not shown in this figure. A body 11 forms a pair of guides 21G which are defined along a length (or height) of such a body 11 and arranged to receive at least a portion of the vertical supports 21V therein. In addition, the vertical supports 21V are arranged to translate or slide along the length (or height) of the body 11. In addition, such vertical supports 21V are disposed over the body 11 and separated therefrom by a preset distance such that the scanning head defines a slit 29 as the longitudinal support 21L translates or slides over the body 11.

In operation, the scanner unit 21 is kept in its rest position when the longitudinal support 21L is disposed along a specific portion of the length (or height) of the body 11. An user places an article on or over the body 11 with a side bearing various visual informations facing upward, and then slides or translates the longitudinal support 21L across the article. During such translating or sliding movement, the scanning head scans and captures various visual informations of the article such as its t-infos or p-infos from the preset distance while moving along with the supports 21L, 21V. As an opposite end of the article is swiped by such a scanning head, a scanning operation is completed and the scanning head may be moved back to its original rest position for a next scanning operation. Alternatively, such a scanning head may stay in the opposite end of the body 11, where the next scanning operation may proceed while the supports 21L, 21V may move in an opposite direction. Similar to the embodiment of FIGS. 2B and 2D, the user may move the scanning head at any speed, and the scanning head may be arranged to scan the article at a preset sampling rate and/or as the article moves thereacross. When desirable, the scanner unit 21 may be arranged to include one or more transporting mechanisms (not shown in the figure), and to move the scanning head 25 over the article at a preset speed.

Another exemplary embodiment of such a scanning unit is described in FIG. 2F which shows a schematic diagram of another exemplary scanner unit including a scanning head rotating over a body according to the present invention. Such a scanner unit 21 similarly includes one longitudinal support 21L extending across a height (or length) of a body 11 and defines a center of rotation 21C in one end of such a support 21L. A scanning head of the scanner unit 21 is similarly implemented along a preset length of a lower surface of such a longitudinal support 21L and, accordingly, not shown in the figure. In addition, the longitudinal support 21L is arranged to rotate or pivot about the center of rotation 21C defined in one end thereof. In addition, the longitudinal supports 21L is disposed over the body 11 and separated therefrom by a preset distance such that the scanning head may define a slit 29 when the longitudinal support 21L rotates about the center of rotation 21C over the body 11.

In operation, the scanner unit 21 is kept in its rest position when the longitudinal support 21L is disposed at a specific angle with respect to a length (or height) of the body 11. An user may place an article on or over the body 11 with a side bearing various visual informations facing upward, and then pivots or rotates the longitudinal support 21L angularly about the article. During the rotating movement, the scanning head scans and captures various visual informations of the article such as its t-infos or p-infos from the preset distance while moving along with the supports 21L, 21V. As an opposite end of the article is swiped by such a scanning head, a scanning operation is completed and the scanning head may be moved back to its original rest position for a next scanning operation. Alternatively, such a scanning head may stay in the opposite end of the body 11, where the next scanning operation may proceed while the supports 21L, 21V may move in an opposite direction. Similar to the embodiment of FIGS. 2B to 2E, the user may move the scanning head at any speed, and the scanning head may scan the article at a preset sampling rate and/or as the article moves thereacross. When desirable, such a scanner unit 21 may be arranged to include one or more transporting mechanisms (not shown in this figure), and to move the scanning head 25 over the article at a preset speed.

In another aspect of the present invention, such an information processing system may include various input members and/or output members each of which may include various audio and/or visual units capable of acquiring and/or displaying various audio and/or visual informations.

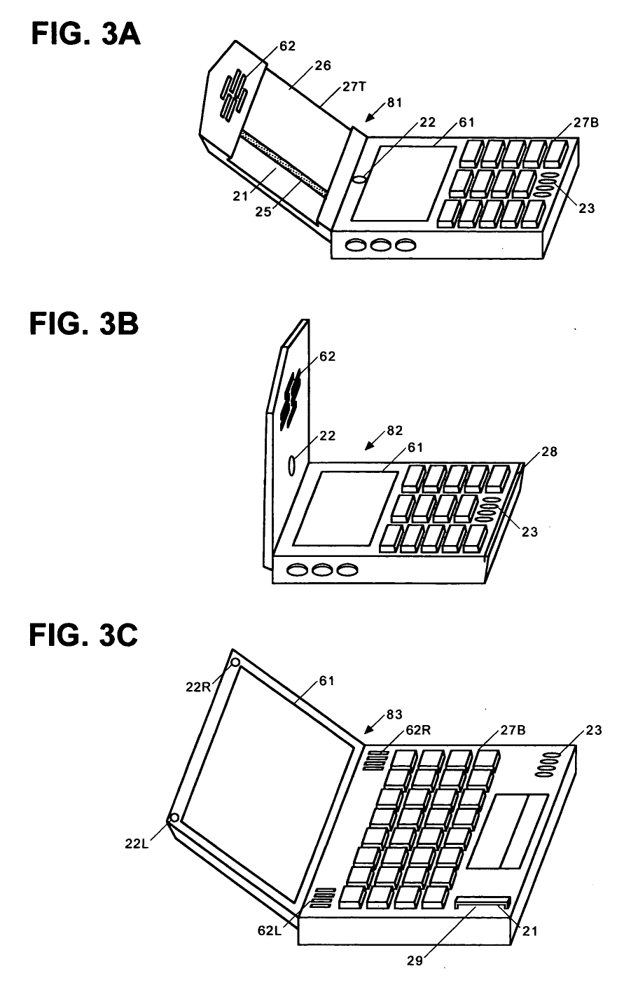

One exemplary embodiment of such an aspect of the present invention is described in FIG. 3A which is a schematic diagram of a cellular phone having therein an exemplary information processing system according to the present invention. Such a cellular phone 81 includes a top portion 27T and a bottom portion 27B, where one of such portions 27T, 27B is arranged to fold toward and away from the other of such portions 27T, 27B. The exemplary cellular phone 81 also includes a microphone 23 and a speaker 62, where the former 23 is implemented in the bottom portion 27B and converts sounds of an user into electrical or optical signals and where the speaker 62 is implemented in the top portion 27T and converts electrical or optical signals into audible sound signals. The cellular phone 81 further includes a display screen 61 which may display various input, output, and/or control signals thereon. Although not shown in the figure, the cellular phone 81 includes a conventional communication module and a storage member, where the former allows the user to send and receive electromagnetic signals to and from other cellular phones or communication stations, and where the latter allows such an user to store various informations therein.

Such a cellular phone 81 includes the information processing system of the present invention which in turn includes the receiving member 20, storage member 30, input member 40, control member 50, and output member, as discussed in conjunction with FIGS. 1A and 1B. The receiving member 20 includes at least one audio input unit and at least one video input unit, where the microphone 23 of the cellular phone 81 may be used as the audio input unit of such a system and where the video input unit 22 may include a conventional camera, lens-CCD assembly, and so on. The storage module of such a cellular phone 81 may be utilized as the storage member 30 (not shown in this figure) or, alternatively, such a system may include the separate storage member 30. Various keys of the cellular phone 81 may also be used as the input member 40 of the system or, in the alternative, the system may include separate keys and/or pads to allow the user to input various commands. The control member 50 (not shown in this figure) may be implemented into a process module of such a cellular phone 81 or, in the alternative, may be provided separately from such a module. The output member 60 includes at least one audio output unit and at least one video output unit, where the speaker 62 may be utilized as the audio output unit, while the display screen 61 may be utilized as the video output unit. In addition, the cellular phone 81 also includes a scanner unit 21 which includes a fixedly disposed scanning head 25 and a recessed area 26 through which an user manually places an article such as a printed medium (e.g., an information card, a business card, and so on), where such a scanner unit 21 is similar to that described in conjunction with FIG. 2B and capable of scanning raw images of the article.

In operation, an user may use the cellular phone 81 for communicating with others. When the user receives a new business card and wants to input new informations, he or she may insert such a card on the recessed area 26 and move the card across the scanning head 25 of the scanner unit 21. By manipulating various keys of the input member, the user may control the control member so as to extract various t-infos and/or p-infos. Using the video output unit 61, the user may rearrange, edit, and/or modify such informations. When desirable, the user may also record sounds of a person who may be related to the information or business card by the audio input unit 23 and/or may take a picture of such a person by the video input unit 22. The user may again manipulate various keys of the input member so as to synchronize such v-infos and/or m-infos acquired by the audio input unit 23, and/or p-infos acquired by the video input unit 22 with the t-infos and/or p-infos which have been already acquired by the scanning unit 21. Thereafter, the user may retrieve the stored informations from the storage member. In the alternative and without using the scanning unit 21, the user may acquire one or more of such v-infos and/or m-infos by the audio input unit 23, and/or p-infos by the video input unit 22. The user may store such informations and/or may also synchronize such informations with other informations which are already stored in the storage member, where details of such synchronizations will be described in greater detail below.

Another exemplary embodiment of such an aspect of the present invention is shown in FIG. 3B which represents a schematic diagram of another cell phone incorporating therein another exemplary information processing system according to the present invention. Similar to that shown in FIG. 3A, a cellular phone 82 of FIG. 3B is comprised of a top portion 27T and a bottom portion 27B, and includes a camera 21, microphone 23, speaker 62, and display screen 61, in addition to a communication module and a storage member which are not shown in the figure. The cellular phone 82 is also implemented with an information processing system which includes an audio input unit such as the microphone 23, a video input unit 22 such as the camera 21, an audio output unit such as the speaker 62, and a video output unit such as the display screen 61. It is appreciated, however, that the video input unit 21 may be disposed in the top portion 27T and that the bottom portion 27B may define a slit 28 across which an user may detachably dispose an information card or a business card.

In operation, the user vertically inserts an information card and/or a business card across the slit 28, with its information-bearing side facing toward the cellular phone 82. The user also moves the top portion 27T of the phone 82 vertically with respect to the bottom portion 27B by about 90 degrees such that a surface of the top portion 27T becomes parallel with the card and that the video input unit 22 may be placed approximately perpendicular or normal to a center of the card by a preset distance. Thereafter, the user may manipulate the video input unit 22 and capture various t-infos and/or p-infos contained in such a card. Other configurational and/or operational characteristics of the information processing system of FIG. 3B are similar or identical to those of the system of FIG. 3A.

Another exemplary embodiment of such an aspect of the present invention is shown in FIG. 3C which represents a schematic diagram of a portable or laptop computer which incorporates another exemplary information processing system therein according to the present invention. An exemplary computer 83 is comprised of a top portion 27T and a bottom portion 27B, where one of such portions 27T, 27B is arranged to fold toward and away from the other of the portions 27T, 27B. The computer 83 also includes a microphone 23 and speakers 62, where the former 23 is implemented in the bottom portion 27B and converts sounds of an user into electrical or optical signals, whereas such speakers 62 are also implemented into opposing corners of the top portion 27T and convert electrical or optical signals into audible sound signals. The computer 83 further includes a display screen 61 which may display various input, output, and/or control signals and/or images thereon. Although not shown in the figure, the computer 83 includes a conventional processing module and a storage member, where the former allows the user to manipulate various informations and where the latter allows an user to store various informations therein.

The computer 83 also includes the information processing system of this invention which has a receiving member 20, storage member 30, input member 40, control member 50, and output member, as discussed in conjunction with FIGS. 1A and 1B. Such a receiving member 20 includes at least one audio input unit and at least one video input unit, where the microphone 23 of the computer 83 may be used as the audio input unit of such a system, and where the video input unit 22L, 22R may include a pair of conventional camera, lens-CCD assembly, and the like. The storage module of the computer 83 may be used as the storage member 30 (not shown in this figure) or, in the alternative, such a system may incorporate a separate storage member 30. Various keys of the computer 83 may also be used as the input member 40 of such a system or, in the alternative, the system may include separate keys and/or pads to allow the user to input various commands. The control member 50 (not shown in this figure) may be implemented into a process module of such a computer 83 or, in the alternative, may be provided separately from such a module. The output member 60 may include at least one audio output unit and at least one video output unit, where the speaker 62 may be utilized as the audio output unit, and where the display screen 61 may be utilized as the video output unit. In addition, the computer 83 also includes a scanner unit 21 which includes a fixedly disposed scanning head 25 and defines a slit 29 through which an user manually disposes an article such as a printed medium (e.g., an information card, a business card, and the like), where such a scanning unit 21 may be similar to that described in conjunction with FIG. 2D and capable of scanning raw images of the article.

In operation, an user may use the computer 83 for various purposes. When the user receives a new business card and wants to input new informations, he or she may insert the card through the slit 29 and then move the card below the scanning head 25 of the scanning unit 21. By manipulating various keys of the input member, the user may control the control member so as to extract various t-infos and/or p-infos. Using the video output unit 61, the user may rearrange, edit, and/or modify such informations. When desirable, the user may also record sounds of a person who may be related to the information or business card by the audio input unit 23 and/or may take a picture of such a person by the video input units 22L, 22R. The user may again manipulate various keys of the input member in order to synchronize such v-infos and/or m-infos acquired by the audio input unit 23, and/or p-infos acquired by the video input unit 22 with the t-infos and/or p-infos which have been already acquired by the scanning unit 21. Thereafter, the user may retrieve the stored informations from the storage member. Alternatively and without using the scanning unit 21, the user may acquire one or more of such v-infos and/or m-infos by the audio input unit 23, and/or p-infos by the video input unit 22. The user may store such informations and/or also synchronize such informations with other informations which have been already stored in the storage member, where details of such synchronizations will be described in greater detail below. Other configurational and/or operational characteristics of such an information processing system of FIG. 3C are similar or identical to those of the system of FIGS. 3A and 3B.

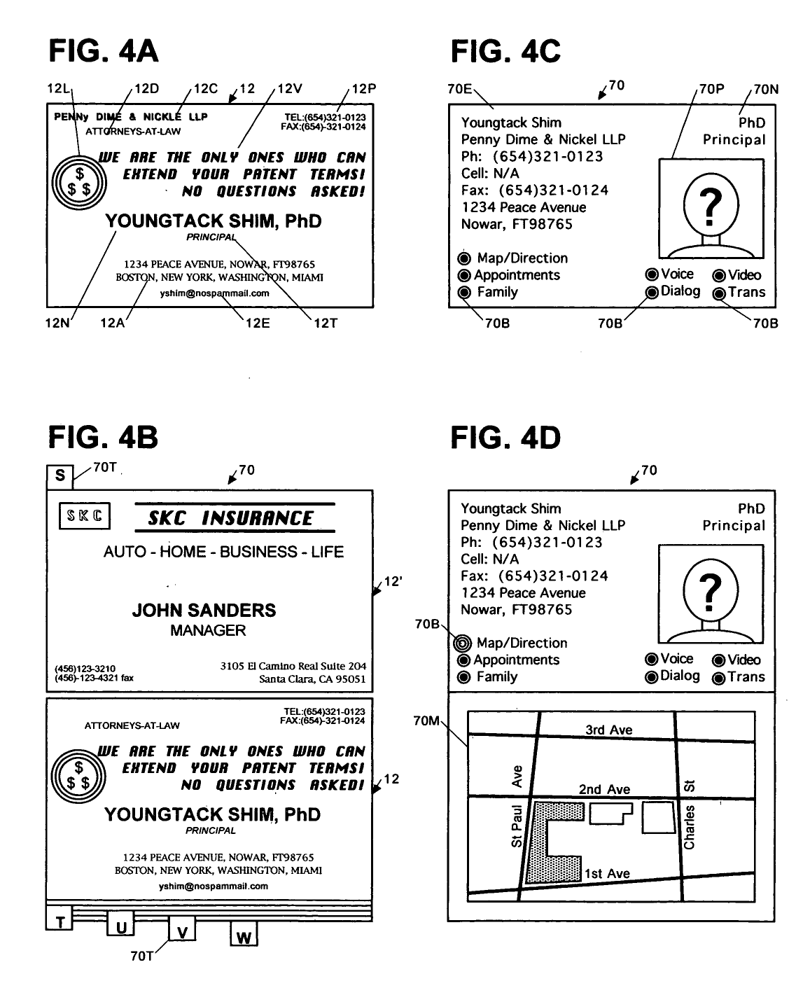

In yet another aspect of the present invention, various information processing systems of the present invention may be arranged to rearrange, edit, modify, and/or otherwise process various raw audio and/or visual informations and to generate various processed audio and/or visual informations. Following FIGS. 4A to 4D describe several exemplary embodiments of such processed informations.

FIG. 4A is a top view of an exemplary raw image of a conventional business card. In general, a conventional card or its raw image 12 carries, from top to bottom, a name of a company 12C, a brief description 12D of a business type engaged by the company, a telephone number and a fax number of the company or person 12P, a logo or insignia 12L of the company, commercial verbiage or slogan 12V adopted by the company, a name of the person 12N, his or her job title 12T, a street address 12A of the company or the person, an e-mail address 12E of the person, and the like.

In one exemplary embodiment of this aspect of the present invention, an exemplary information processing system may be arranged to acquire a raw image of an article such as a printed medium or a business card, to store such a raw image, and then to simply display the raw image thereof without rearranging, editing, and/or modifying such. Such an information processing system may generally be arranged to allow an user to save multiple raw images of different articles, media, and/or cards in the storage member and to refer to them according to preset orders, where examples of such orders may include, but not be limited to, alphabetical orders of various informations such as names of persons or companies, phone or fax numbers of the persons or companies, other categories such as, e.g., family members, in-laws and their family members, friends, business acquaintances, and the like. Even such a simplest embodiment may offer significant benefits over its conventional counterpart, because such an information processing system may not only free the user from manually typing in various essential informations into the conventional devices but also save the user from carrying a thick stack of cards in a wallet or pocket.

In another exemplary embodiment of such an aspect of the present invention, FIG. 4B shows a schematic view of an exemplary processed image of stacked raw images of FIG. 4A according to the present invention. This information processing system may be similar to that of the above paragraph, but arranged to display multiple raw images of different articles side by side and/or one over the other for better references, similar to a stack of business cards collected in the Rolodex but disposing their information-carrying sides facing each other. More particularly, processed images 70 of such cards may be arranged in various orders such that the user may be able to view and flip multiple processed images 70. Other options may also be implemented thereto. For example, similar to conventional card stacks, multiple alphabetical tabs 70T may be provided along a top, bottom, and/or sides of the images 70 such that the user may look up one portion and may then jump to another portion of the processed images.

In another exemplary embodiment of such an aspect of the present invention, FIG. 4C shows a schematic view of another exemplary processed image of informations extracted from the raw image of FIG. 4A and other raw images according to the present invention. Such an information processing system may be arranged to extract various informations from such raw images, optionally rearrange, edit, modify, and/or otherwise process such raw images and/or various informations so as to provide various processed images according to a preset format. More particularly, a control member 50 of the system is arranged to process, based upon user selection, includes a first extraction unit arranged to recognize the alphanumerals and characters from the raw image of the card 12 as well as a second extraction unit arranged to crop a head portion of the person from his or her raw image and to resize the portion in order to fit it into a preset space provided in a processed image. The processed image 70 is generally divided into different sections which may be arranged to display, e.g., essential t-infos 70E, nonessential t-infos 70N, and p-infos 70P. In addition, the processed image 70 may also include multiple buttons 70B of links which may be arranged to fetch and display additional informations which are not included in the processed image 70. Examples of such additional informations may include, but not be limited to, a p-info regarding a map which shows the direction to the person's company, a t-info listing all future and/or past appointments with that person such as meetings and phone calls, another t-info regarding names and birthdays of the family members of the person, a v-info including a sample voice of the person, another v-info recording entire conversations with that person, a v-info including dynamic images of the person or meeting with that person, another t-info regarding a transcript of the conversation with that person, and the like.

In another exemplary embodiment of such an aspect of the present invention, FIG. 4D shows a schematic view of the exemplary processed image of informations of FIG. 4C with one of its functions selected according to the present invention. For example, a processed image 70 includes a top image and a bottom image, where the top image corresponds to that of FIG. 4C, and where the bottom image corresponds to a new processed image when the user selects the map/direction button 70B of that of FIG. 4C. Upon receiving such a command signal through the input member, the control member 50 may fetch the p-info of a map and/or direction adjacent to and/or leading to an address acknowledged and listed in the processed image of FIG. 4C, and display the map and/or direction as the p-info (or t-info) on the visual output unit 61. Such a map and/or direction to the address may be directly obtained from the storage member 30 or, in the alternative, by a GPS unit which may be activated by the user upon selecting the button 70B.

The information processing systems of the present invention offer many benefits not only over conventional hardware counterparts (e.g., electronic organizers or PDAs) but also over conventional information arrangement software equipped in almost all computers. First, the information processing systems of this invention incorporate various receiving units to acquire the raw images and/or sound and, therefore, obviate the need of having to type in all relevant informations into various hardware or software. Second, such systems of this invention also allow the user to synchronize different types of informations (e.g., t-info, p-info, v-info, and m-info) in almost any possible format of one's choice. Therefore, the user may look up a person's phone number or address while looking at his face and/or listening to his voice, thereby facilitating prior experience associated with such a person. In addition, such informations may not have to be acquired simultaneously by the information processing system either. Accordingly, the user may update his or her database whenever a new information becomes available, e.g., through directly obtaining such informations from a person, obtaining such informations second-handedly, obtaining such informations stored in other storage and/or processing devices, and the like.

The foregoing exemplary embodiments of the information processing systems, their members, and/or their units may be modified and/or arranged to have additional characteristics according to the present invention. It is appreciated that following modifications and/or characterizations of the above systems, members, and units may readily be applied to other exemplary systems, members, and units which have been described heretofore and will be described hereinafter unless otherwise specified.

The scanner unit of the receiving member may be designed according to various conventional and/or novel configurations. For example, the scanner unit may be constructed similar to conventional scanners, although this embodiment would require more hardware parts and occupy bigger space to accommodate a movable optical scanning head. In the alternative and as described in FIGS. 2B to 2F, the scanner may be arranged to have a stationary head which is fixedly coupled to other parts of the system and across which the user is to manually move the printed medium. In addition, such scanning heads may be arranged to be pulled out and/or rotated out of the system, and the user may move the heads on or over the printed medium as well. The scanner units according to these embodiments may preferably require calibration units such as calibrating rollers to sense movements or displacements of the scanning head across the medium and to determine the size of the captured raw image according to such movements or displacements.

Alternative, the scanner unit may employ a lens-CCD assembly to capture the raw image of the printed medium, where one of such embodiments has been exemplified in FIG. 3B. Such an assembly may include one or more lenses and, when desirable, may be equipped with a wide-angle lens and/or a zoom mechanism in order to capture small letters and/or figured carried by various articles. Such a scanner unit may include a stationary scanning lens-CCD assembly which is fixedly coupled to other parts of the system or, in the alternative, a mobile lens-CCD assembly at least a portion of which may be pulled and/or rotated between its rest and use positions. Such a scanner unit may be arranged to capture various visual informations carried by an article which may be disposed at a variable distance by, e.g., adjusting its focus. Alternatively, the information processing system may define a location in which such an article is to be disposed so that the scanner unit may capture the visual informations of the article disposed at a preset distance, without having to adjust its focus.

The video input unit of the receiving member may be arranged to have various configurations as well. For example, the video input unit may be arranged to operate similar to digital cameras and to acquire a still raw image of a person or object. In the alternative, the video input unit may be arranged to operate similar to digital camcorders to acquire dynamic raw images of the person or object. When desirable, multiple video input units may also be used to obtain the raw images of the person or object acquired at the same instant but at different view angles. These multiple images may subsequently be processed by the control member to construct, e.g., a stereo image, a three-dimensional image of the person or object, and so on. The video input unit may preferably have a reasonable resolution so that the control member may be able to extract relevant t-infos therefrom. It is appreciated that, as long as the video input unit may acquire such raw images, detailed configuration thereof may not be material to the scope of the present invention.

Such scanning units and video input units may be arranged to capture monochrome images or color images. These units may also include at least one optical filter and/or at least one digital filter so as to remove a specific color from the raw and/or processed images. In addition, the scanning and/or video input units may further include a conventional image enhancing unit which may be arranged to interpolate and/or extrapolate the raw images.

The audio input unit of the receiving member includes one or more conventional microphones to capture raw sounds propagating through a surrounding medium such as air. Similar to the video input unit, the audio input unit may also include multiple microphones disposed apart and arranged to acquire the raw sounds in a stereo mode. As long as the audio unit may be able to such raw sounds, detailed configuration thereof may not be material to the scope of the present invention.

The receiving member may also include receiving units other than those described above. For example, at least one input/output connection unit 24 of FIG. 1B may be provided to import informations stored in other information storage media such as, e.g., DVDs, CDs, hard disks, floppy disks, magnetic tapes, microchips, magnetic stripes, optical disks, and other storage media arranged to store analog or digital informations therein. Such a connection unit may also be linked to and fetch informations from stationary conventional devices such as desktop computers, from portable conventional devices such as, e.g., laptop computers, PDAs, cell phones, data organizers, palm devices, and other conventional devices arranged to process analog and/or digital data. Such a connection unit may also be linked to networks such as e.g., local networks, municipal networks, worldwide webs. The receiving member may be arranged to communicate wirelessly with, e.g., the above storage media, above conventional stationary and/or portable devices, and/or above networks. Therefore, such a storage member may be equipped with requisite hardware and software for conventional wireless communications and/or wireless optical communications. It is appreciated that exact locations of such receiving units may be generally not material to the scope of the present invention as long as such units do not hinder proper operations of the information processing system of this invention.

The storage member may be provided in a variety of configurations as long as such a member may receive, store, and send various digital and/or analog informations. Any conventional information storage media may be used as the storage member examples of which may include, but not be limited to, RAMs, ROMs, flash memories, other semiconductor memory chips, DVDs and drivers thereof, CDs and drivers thereof, hard and/or floppy disks and drivers thereof, magnetic tapes and players thereof, optical disks and drivers thereof, magnetic stripes and encoders and/or decoders thereof, microchips, and so on. Such storage media may be installed inside the body of the information processing system or may be provided as an external unit. When the information processing system may be designed to be retrofit into the conventional stationary or portable data processing devices, such a system may be arranged to use data storage media of such devices. Regardless of internal or external disposition of the storage member, such a member may be arranged to operatively couple and/or communicate with other members of the system through the connection wire or wirelessly.

As described above, the control member of the information processing system may include at least one extraction unit arranged to analyze the raw images and/or sounds and to extract relevant t-infos, p-infos, v-infos, and/or m-infos therefrom. For example, the control member may include a first extraction unit such as a character recognizing unit which is capable of extracting the t-info from the raw image of the printed medium and/or the object bearing printings thereon. The control member may include a second extraction unit such as an image analyzing unit arranged to analyze the p-info from the raw image of the person and/or object, to recognize a specific or entire portion of the image, and to reshape, resize, and/or rearrange the select portion of the image. The control member may further include a third extraction unit such as a voice analyzer or voice converter capable of extracting the t-info from the conversation or vocal song and/or to extract the v-info by analyzing harmonic features of the conversation, vocal song, background noise, instrumental music, and other audible or inaudible acoustic waves. Such a control member may include a fourth extraction unit arranged to extract the m-info from the vocal songs and/or instrumental music. It is noted that the above extraction units may be arranged to automatically extract various informations by themselves or may be arranged to do so through a guidance and/or feedback from the user. For example, a character recognizing unit may be arranged to extract the t-info based entirely on the raw image of the printed medium. Several heuristic rules may also be implemented to the character recognizing unit so that, e.g., in the case of extracting various t-infos from the raw image of a business card, such a unit recognizes the name of the person as a group of the largest characters thereon, the phone and/or fax numbers of the person as a group of about six or more numerals, the title of the person as a group of characters disposed most adjacent to the name of the person, the e-mail address as a group of characters without any space and having a symbol “@” therein, the web site as a group of characters including “www” in the front, and so on.

The foregoing extraction units may be arranged to interact with the user to recognize relevant t-infos from the raw image of the business card, address book, phone book, and/or document with a better accuracy. For example, after the receiving member acquires the raw image including various t-infos thereon, the output member displays such a raw image, and the extraction unit sends a series of queries to the user regarding locations of specific t-infos in a preset order. The user may send to the extraction unit a series of signals each of which represents the location of the t-info by, e.g., moving a cursor to or displacing a stylus on a region of a display screen, and then sending a control signal to the extraction unit by, e.g., clicking a selection button or pushing the region of the display screen with the stylus. The foregoing extraction units may also be arranged to interact with the user to recognize relevant p-infos from the raw image of the person or object. For example, after the receiving member acquires the raw image including various p-infos thereon and the output member displays such a raw image, the extraction member may allow the user to designate a circular or rectangular region on the raw image and then select only the designated portion of the image. Similar embodiments may also be applied to the extraction members for the v-infos and the m-infos. Other interactive embodiments may also be employed to assist the extraction unit to better recognize the relevant t-infos, p-infos, v-infos, and m-infos, as long as the control member provides proper links between its extraction units and the input member.

Various filter and enhancing units may be provided to the control member in order to assist the foregoing extraction units. For example, conventional image filter units analyze the raw image to filter out noise signals from the raw images, and conventional image enhancing units may enhance quality and/or resolution of the picture by interpolation and/or extrapolation techniques. Conventional sound filter unit may analyze the raw sounds to filter out high-frequency and/or low-frequency noises from the raw sounds as well. Such filter units may employ any conventional filtering techniques such that the noises may be taken out based on fixed filtering algorithms and/or adaptive filtering algorithms.

The control member may include at least one processor unit arranged to edit and/or modify the raw images and/or sounds to provide the processed images and/or sounds. The processor unit may edit the raw or interim image or sound by, e.g., creating a new file of such an image or sound, adding or deleting certain features to or from such an image or sound, copying or pasting certain features or portions of such an image or sound, and so on. The processor unit may modify or change the raw or interim image or sound as well by, e.g., reshaping (i.e., changing the shape or font of such an image), resizing (i.e., enlarging or shrinking) such an image, coloring or changing the color of such an image, changing arrangements of certain features of such an image, and so on. Therefore, such processor units may edit and/or modify the raw images and provide the processed image which includes the t-infos and/or p-infos having different configurations from those of the raw image. The processor unit may also be arranged to edit and/or modify the raw sound and provide the processed sound including the v-infos and/or m-infos having different configurations from those of the raw sound.

The above processor unit may also be arranged to analyze or compare multiple informations of the same type or different types. For example, a first processor unit may compile the t-infos, p-infos, v-infos, and/or m-infos of a specific person or object in a preset arrangement and synchronize some or all of such informations in a preset format. When desirable, different types of informations may be compiled and/or synchronized for a specific set of people who may belong to a certain group (e.g., a company or family) or have a common trait (e.g., a profession, age or ethnicity), and the like. Similarly, different type of informations may also be compiled and/or synchronized for a specific set of objects belonging to a certain group, having a common trait, and so on. Conversely, a second processor unit may compile a specific type of informations of different persons and/or objects and synchronize all or some of such informations in a preset format as well. Thereafter, such processor units may generate the processed images and/or sounds by disposing such synchronized informations in a preset pattern as exemplified in FIGS. 2C and 2D.

The control member may also include at least one converter unit arranged to convert one type of information into another type of information. For example, a first converter unit may be arranged to convert a t-info into a p-info, e.g., by transcribing such a t-info which may be imported from external stationary or portable devices, extracted by the foregoing extraction unit, and/or stored in the storage member. The p-info may subsequently be displayed on the visual output unit or printed by a printer. A second converter unit may also be arranged to convert a t-info into a v-info by, e.g., synthesizing the voice of the person and superposing the t-info thereonto. It is appreciated, in such an aspect, that the above extraction units such as the character recognizing units may also be regarded as the converter unit arranged to convert the p-info into the t-info.

The control member may further include at least one superposition unit arranged to superpose one type of information onto another type of information. For example, a first superposition unit may be arranged to superpose the t-info onto the p-info, v-info, and/or m-info to synchronize such a t-info with other informations or vice versa. Similarly, a second superposition unit may superpose the p-info onto the t-info, v-info, and m-info to synchronize the p-info with other information or vice versa. Other informations such as the v- and m-info may also be arranged to be superposed to other informations as well.

Various receiver and/or data transfer units may be provided to the control member to facilitate information transfer into, from or between different members of the information processing system of this invention. For example, a receiver unit may be implemented to receive the user commands and to deliver such directly to the foregoing various units of the control member, e.g., to the extraction unit of the control member during the assisted image and/or sound extraction processes as described above. In contrary, a data transfer unit may be arranged to transfer informations between different members of the system such that it may, e.g., retrieve various raw, interim, and/or processed informations from the storage member, store such informations in the storage member, send various informations to the output member, and the like. When desirable, a transmitter unit may further be implemented to transmit relevant informations to other information processing systems so that the user may transmit his or her essential and/or nonessential informations to such information processing systems of other persons through a connection wire or wirelessly. It is appreciated in this embodiment that such a system may not necessarily require the scanning unit when the system is designed to receive the t-infos of others only through their information processing systems of this invention.

As described above, the control member of the information processing system may preferably be arranged to monitor and/or control various operations of other members thereof. More particularly, the control member may interact with various receiving units of the receiving member and manipulate which receiving unit may be activated to acquire a certain raw image and/or sound. For each of such receiving units, the control member may also control an acquiring speed and/or resolution of the raw image and/or sound, a view angle of the raw image, selection of a still or dynamic mode for the image acquisition, an acquisition volume of the raw sound, activation or deactivation of any filter units during the raw sound acquisition, selection of a digital or analog mode for the raw image and/or sound, and so on. The control member may interact with the storage member to determine whether to store such informations in an analog or digital mode, which format such informations may be stored, activation or deactivation of data compression unit, and the like. The control member may also interact with various output units of the output member and may manipulate which unit may be activated to output a certain processed image and/or sound. For each of such output units, the control member may also control a display speed and resolution of the processed image and/or sound, a volume of the processed sound, activation or deactivation of any filter units during the output, selection of a digital or analog mode for the processed image and/or sound, and so on.

The control member may further include other optional units to perform various auxiliary tasks. For example, the control member may include a GPS unit arranged to interact with GPS satellites and to obtain therefrom a map of a relevant area as discussed in FIG. 4D. The control member may include a recorder unit arranged to record preset events such as phone calls to and/or from persons whose t-infos such as phone numbers, names, company names or contents of conversations, v-infos such as voices, and/or p-infos such as appearances are analyzed and stored in the storage member. By recognizing such informations through the person's messages in the answering machine or mail box, his or her voice, and/or the person's appearance displayed on a screen of a video- or internet phone, the recorder unit may record such an event and display a time, date, and contents of the event when requested by the user thereafter. The recorder unit may further record the preset events using other informations examples of which may include, but not be limited to, meetings using the p-infos such as the person's appearance and/or background view, various correspondences using the t-infos such as the name, address, and/or logo of the person or company, e-mails using an e-mail address or name of the person, visits using the t-infos such as the street address, GPS informations, and/or p-infos of the background view of the place, and the like. The recorder unit may be arranged to record and keep track of such events automatically, semi-automatically in conjunction with user's command or manually by the user. The control member may include an alarm unit which may interact with other units of the control member and may alarm the user with upcoming and/or missed appointments. For example, the alarm unit may be arranged to announce such appointments visually or audibly in advance, cancel the event from a list of the upcoming events after recognizing that the user actually fulfill the appointment, and supply the user with a list of missed appointments in case the user should fail to do so.

The input member of the information processing system of this invention may also be provided in various embodiments. As described herein, such an input member is generally arranged to receive tactile or vocal commands from the user through its input units examples of which may include, but be limited to, conventional keypads, keyboards, touch pads with or without styluses, touch screens with or without styluses, joysticks, arrow keys, selection buttons, and the like. Such input units may also be arranged to receive the user commands wirelessly using, e.g., radio waves, short waves, optical signals, and the like. The input units may be arranged to receive digital and/or analog user command.

The output member of the information processing system of this invention may include various output units such as, e.g., video output units, audio output units, signal outlet units, encoders, drivers, and the like. First, the video output unit generally includes a display screen such as, e.g., a LCD, LED, OLED, CRT, passive or active matrix screens, and other conventional screens. When desirable, such a video output unit may include a thermal or ink jet printer to print out a black-and-white or color output. In contrary, the audio output units may include one or more speakers to effect mono or stereo sounds. The signal outlet units may generally be arranged to send analog and/or digital signals representing the processed images and/or sounds to other conventional information processing devices such as, e.g., computers, printers, microchip encoder, magnetic stripe encoder, drivers for the DVDs, CDs, hard or floppy disks, and so on. An example of the outlet unit is discussed as the input/output connection unit 24 in FIG. 1B. Various encoders and/or drivers may also be included in the output member to encode or download the processed images and/or sounds onto the microchips, magnetic stripes, DVDs, CDs, hard disks, floppy disks, and the like.

The information processing system may include at least one power source to supply electrical energy to various members thereof. In general, such a system includes a rechargeable battery such that the system may be used as a portable unit, and also includes a connection port for an adaptor to be connected to an AC power and to recharge the battery.

It is appreciated that various receiving units of the receiving member, various input units of the input member, and/or various output units of the output member may be fixedly or detachably disposed to the body of the information processing system depending upon various design considerations. For example and as illustrated in FIG. 1B, various units may be fixedly disposed on or inside the body such that the system itself becomes self-sufficient and operational. Alternatively, some of the foregoing units may be provided as separate articles and coupled to the body only when such units are in use. Such an embodiment may offer the benefit of reducing the size of the information processing system of this invention. In addition, when such a system may be incorporated to be retrofit into conventional information processing devices, the detachable arrangement may obviate redundant installation of the receiving and/or output units of the system. It is also appreciated that detailed electrical wiring of the foregoing members and/or units of the information processing systems of this invention is not material to the scope of the present invention. Such wiring techniques and wireless equivalents thereof are generally well known in the relevant art of electrical engineering. It is further appreciated that various algorithms arranged to perform the aforementioned tasks of the information processing systems of the invention are also included within the scope of this invention.

It is appreciated that the information processing system may consist mainly of software which may incorporate one or more of the above scanning units and other hardware and/or connectors for connecting the scanning units with conventional information processing and/or storage devices. It is also appreciated that not all of the foregoing units of the receiving, input, and/or output members may have to be incorporated into the information processing system of this invention.

It is to be understood that, while various aspects and/or embodiments of the present invention have been described in conjunction with the detailed description thereof, the foregoing description is intended to illustrate and not to limit the scope of the present invention, which is defined by the scope of the appended claims. Other embodiments, aspects, advantages, and/or modifications of the above aspects and/or embodiments are within the scope of the following claims.

What is claimed is:

1. A system for processing a plurality of informations comprising:
a body;
at least one receiving member disposed in said body and configured to acquire at least one of a raw image and a raw sound;
at least one control member disposed in said body and configured to receive a user command, to operatively couple with said receiving member, to extract at least one of a text information, a picture information, a voice information, and a music information from at least one of said raw image and said raw sound, to process at least one of said informations based said user command, and to prepare at least one of a processed image and a processed sound; and
at least one output member disposed in said body and configured to be coupled to said control member and to output at least one of said processed image and said processed sound.

2. A system for processing a plurality of informations comprising:
a body;
at least one receiving member disposed in said body and configured to acquire at least one of a raw image and a raw sound;
at least one control member disposed in said body and configured to receive a user command, to operatively couple with said receiving member, to extract at least one of a text information, a picture information, a voice information, and a music information from at least one of said raw image and said raw sound, to process said text information, to process at least one of said picture information, said voice information, said music information, and another text information based on said user command, and to prepare at least one of a processed image and a processed sound; and
at least one output member disposed in said body and configured to be coupled to said control member and to output at least one of said processed image and said processed sound.

3. The system of claim 2, wherein said receiving member includes a scanning unit configured to scan a printed medium and to acquire said raw image provided on said printed medium.

4. The system of claim 2, wherein said receiving member includes a video input unit configured to acquire said raw image of at least one of a person and an object disposed in front of said video input unit.

5. The system of claim 2, wherein said receiving member includes an audio input unit configured to acquire said raw sound propagating through a medium surrounding said system.

6. The system of claim 2, wherein said output member includes a video output unit configured to display said processed image.

7. The system of claim 2, wherein said output member includes an audio output unit configured to play said processed sound.

8. The system of claim 2, wherein at least a portion of at least one of said receiving and output members is configured to be detachably coupled to said body.

9. The system of claim 2, wherein said receiving member is configured to receive said raw image at a first instant and said raw sound at a second instant which is independent of said first instant.

10. The system of claim 2, wherein said receiving member is configured to receive one of said raw images at a first instant and another of said raw images at a second instant which is independent of said first instant.

11. The system of claim 2, wherein said output member is configured to output a plurality of said processed images at least one of simultaneously and sequentially.

12. The system of claim 2, wherein said output member is configured to output said processed image and sound synchronously.

13. The system of claim 2, wherein said control member us configured to process said at least one of said information through at least one of creation, addition, deletion, copying, and pasting of at least one of said raw image, raw sound, and informations.

14. The system of claim 2, wherein said control member us configured to process said at least one of said information through at least one of reshaping, resizing, recoloring, and rearrangement of at least one of said raw image, raw sound, and informations.

15. The system of claim 2 further comprising at least one input member configured to receive at least one user command.

16. The system of claim 2 further comprising at least one storage member configured to store at least one of said raw image, raw sound, text information, picture information, voice information, music information, processed image, and processed sound.

17. The system of claim 16, wherein said storage member is configured to store said at least one of said images, sounds, and informations at least one of temporarily and permanently.

18. A method of processing informations comprising the steps of:
acquiring at least one of a raw image and a raw sound independently;
extracting at least one of a text, picture, voice, and music information therefrom;
processing at least one of said different informations;
preparing at least one of a processed image and sound by said processing; and
outputting at least one of said processed image and said processed sound.

19. The method of claim 18, said acquiring comprising at least one of the steps of:
capturing said raw image of an information card of a person;
capturing said raw image of an appearance of said person;
capturing said raw image of an office of said person;
recording said raw sound of a voice of said person; and
recording said raw sound of a background noise around said person.

20. The method of claim 18, said outputting comprising at least one of the steps of:
displaying said processed image;
displaying a plurality of said processed images;
playing said processed sound; and
displaying said processed image in synchronization with said processed sound.
